(19) United States
(12) Patent Application Publication
(10) Pub. No.: US 2016/0072180 A1
(43) Pub. Date: Mar. 10, 2016

(54) ATTACHMENT FOR A MOTOR VEHICLE AND ASSOCIATED MOTOR VEHICLE

(71) Applicant: AUDI AG, 85045 Ingolstadt (DE)

(72) Inventor: Christoph ULLRICH, Ingolstadt (DE)

(73) Assignee: AUDI AG, 85045 Ingolstadt (DE)

(21) Appl. No.: 14/782,953

(22) PCT Filed: Mar. 29, 2014
(86) PCT No.: PCT/EP2014/000846

§ 371 Date: Oct. 7, 2015

(30) Foreign Application Priority Data
Apr. 8, 2013 (DE) 10 2013 006 056.7

(51) Int. Cl. H01Q 1/32; H01Q 21/00; H01Q 1/50

(52) U.S. Cl. CPC H01Q 1/3266; H01Q 1/50; H01Q 1/3275; H01Q 21/0006

(57) ABSTRACT

An attachment for a motor vehicle, is disclosed with at least one antenna having a conductor track for sending and/or receiving radio signals, wherein the attachment and the at least one conductor track of the antenna are designed as an injection moulded interconnect device.

The invention relates to an attachment for a motor vehicle, with at least one an antenna, which has a conductor path for transmitting and/or receiving radio signals.

Nowadays, motor vehicles are in most cases already equipped with multiple antennas that are connected with various communication devices. Radio reception requires at least one antenna, oftentimes vehicles are even equipped with multiple antennas. A further antenna is required for using a mobile phone. In addition various systems are being developed that enable a car-to-car communication. It is sought to integrate the required additional antenna into a roof antenna. The car-to-car communication is based on the fact that vehicles transmit information via radio transmission to vehicles present in the vicinity and to receive information transmitted by other vehicles, which establishes a radio network via which for example warnings can be relayed in a very short time.

In vehicles that have a roof antenna and a vehicle roof that declines toward the rear, no direct line of sight from the antenna towards the front exists. Because wave propagation for the used frequencies predominantly occurs along the line of sight, a good communication is only possible toward the rear, toward the sides or toward the top. The power given off toward the front is reduced by a glass roof arranged in front of the roof antenna. Because wave propagation of a roof antenna toward the front is insufficient it has been proposed to integrate a second car-to-car antenna in the vehicle, which has a direct line of sight toward the front.

In DE 2008 005 908 A1 an attachment for a vehicle is proposed which has an antenna which has at least one conductor path.

In DE 10 2010 064 086 A1 it is proposed to integrate two antennas in vehicle components, wherein the antennas are arranged at corresponding positions on the left and right hand side on the vehicle.

In DE 28 39 849 A1 it is proposed to use a free space within a mirror trim in order to accommodate receiving antennas. Because the trim has to enclose the antenna in addition to the mirror, a correspondingly large dimensioned trim is required.

A roof antenna for a motor vehicle is known from DE 10 2005 054 286 A1. The cladding of the roof antenna is coated with an electrically conducting material, which serves as a functional antenna element. Besides this, the electronic components of the antenna are arranged within the cladding.

The invention is based on the object to set forth an attachment for a motor vehicle with an antenna function, which ensures a good receiving and transmitting efficiency toward the front and rear and only requires a small installation space.

For solving this object it is provided in an attachment of the aforementioned type that the at least one conductor path of the antenna is configured as injection molded conductor path carrier.

The invention is based on the idea that a vehicle antenna can be obtained which requires only a small installation space, when the attachment itself includes the conductor path of the antenna. In this way antenna components can be integrated in an already present attachment so that no additional installation space for antenna components is required. Correspondingly an additional vehicle antenna can be relatively easily integrated in the attachment.

According to the invention, the attachment has the conductor path of the antenna, and is configured as injection-molded interconnect device. The term injection-molded interconnect device usually refers to electrical or electronic components that have metallic conductor paths that are applied onto an injection-molded plastic part which serves as a carrier. Because the attachment is configured as injection-molded interconnected device it can serve a primary function, i.e., it can serve as a cladding or cover, as well as a secondary function, i.e., it can serve as a carrier for one or multiple conductor paths. This results in a multifunctional component, which has advantages regarding the required installation space compared to a conventional arrangement, in which a separate antenna is arranged in the interior of an attachment.

According to the invention it is particularly preferred that the conductor path of the attachment is electrically connected to a coaxial cable, at least a portion of which forms a component of the injection-molded interconnected device. When the conductor path of the attachment is electrically connected to a coaxial cable, no additional installation space for the contacting of the coaxial cable is required.

Particularly preferably, the attachment according to the invention is configured as mirror base of an interior rear mirror. When the attachment, which has the antenna is configured as mirror base of an interior rear mirror, a very good transmitting and receiving efficiency toward the front in driving direction results. Because the conductor path is configured as injection-molded interconnected device an enlargement of the mirror base is not required.

According to an alternative embodiment of the invention the attachment can be configured as a component of the front panel of the motor vehicle. In this variant the conductor path of an antenna can be arranged in the front region in a panel made of plastic.

According to a refinement of the invention the attachment can have multiple antennas and/or multiple conductor paths. Multiple antennas can be provided in order to optimize reception from different directions, in addition also multiple antennas can be provided for different frequencies.

A particularly good integration of the antennas having the conductor paths into the attachment results when a conductor path of an antenna has a three-dimensional shape adapted to the shape of the attachment. The shape of the conductor path is thus adapted to the shape or outer contour of the attachment, in particular to the shape of the mirror base of an interior rear mirror. The antenna can then be practically integrated into the mirror base without requiring additional installation space. Because no additional attachments are required, the costs of providing a further antenna are relatively low.

The invention also relates to a motor vehicle with at least one attachment and at least one antenna for transmitting and/or receiving radio signals, which has a conductor path.

The motor vehicle according to the invention is characterized in that the attachment and the at least one conductor path of the antenna are configured as an injection-molded interconnected device.

The dependent claims set forth further embodiments of the invention.

In the following further advantages and details of the invention are explained with reference to the drawings. The drawings are schematic representations and show:

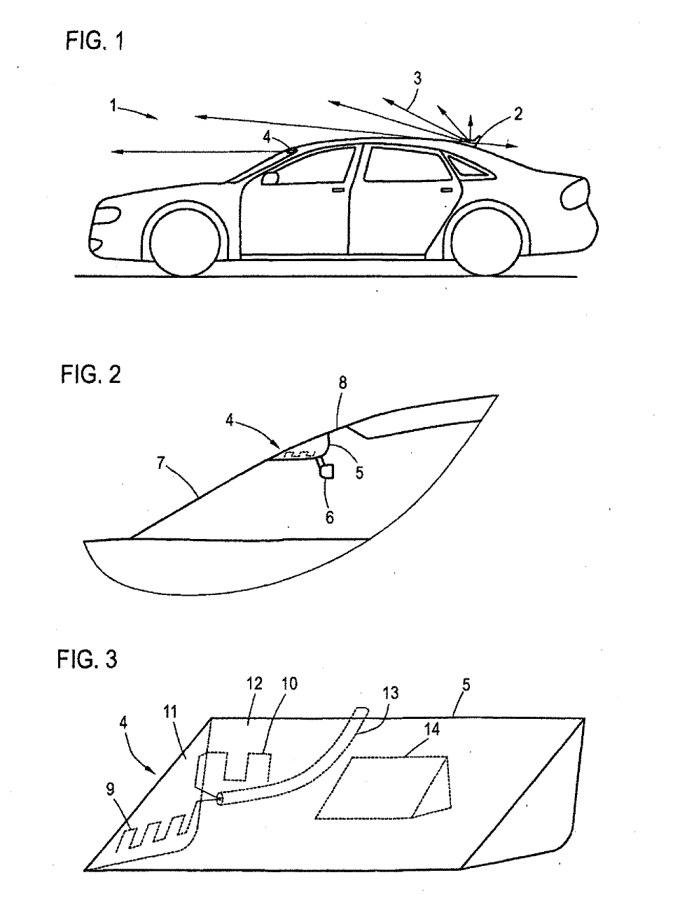

FIG. 1 a side view of a vehicle according to the invention with an attachment according to the invention;

FIG. 2 an enlarged representation of the attachment according to the invention; and

FIG. 3 a perspective view of an attachment according to the invention.

FIG. 1 is a side view of a motor vehicle 1, which has a roof antenna 2. In the roof antenna 2 multiple antennas are integrated, wherein one antenna enables a connection with a mobile radio network and a further antenna is provided for a car-to-car communication. The arrows 3 originating from the roof antenna 2 indicate the directions in which a transmission or radiation of electromagnetic waves is possible. It can be seen that a good radiation occurs toward the rear and the top, however, not toward the front. However, for certain car-to-car applications a reception and transmission in the direction of the front is particularly important, for example in order to receive wirelessly transmitted information of approaching vehicles and to wirelessly transmit information to the approaching vehicles. The motor vehicle 1 according to the invention therefore additionally has a further antenna 4, which is integrated in a mirror base 5 of an interior rear mirror 6. The antenna 4 is arranged to enable radiation and reception of waves toward or from the front.

FIG. 2 shows the region of the antenna 4 at a larger scale. The mirror base 5 is an attachment, which is arranged on the upper end of a windshield 7 in the vehicle interior 8. On the mirror base 5 the interior rear mirror 6 is arranged. In the interior of the mirror base 5 further components are arranged, for example a camera, rain sensors and optionally a current supply for the interior rear mirror 6.

The attachment configured as mirror base 5 has, as a component of the antenna 4, at least one conductor path, which is schematically shown in FIG. 2 and has a meander shape. The shape and length of the conductor path is determined and optimized with regard to the radio frequency(ies).

The antenna 4 with the conductor path is integrated into the attachment, which is constructed as mirror base 5 and configured as injection-molded interconnected device. This means that the attachment and the conductor path are configured as integral component. During the production of the attachment, which is configured as mirror base 5, a base body, which determines the outer contour, is formed in the two-component injection molding process, using a defined plastic. A further second plastic is metallizable and forms the layout of the conductor path. Different production methods exist for producing an injection-molded interconnected device, for example the conductor path geometry can first be configured elevated, and subsequently regions between the conductor paths can be filled with a non-metallizable plastic. In an alternative method the structure of the conductor path is molded as indentation in a first injection shot of the injection process from a non-metallizable plastic. In a second injection shot the indented regions are filled with a metallizable component. Onto the metallizable plastic copper or another conductive material can be galvanically applied.

FIG. 3 is a perspective view of the mirror base 5. In the shown exemplary embodiment the mirror base 5 has an approximately prismatic, hollow base shape. The antenna 4 includes a first conductor path 9 and a second conductor path 10, which both have a meander shape and are a component of the mirror base 5. The mirror base 5, which is configured as injection-molded interconnected device, thus has surfaces 11, 12, that are provided with the conductor paths 9, 10 of the antenna 4. The shape and arrangement of the conductor paths 9, 10 is selected for optimal efficiency of the antenna. The contact of the conductor paths 9, 10 is accomplished via a coaxial cable 13, which is connected to a control unit, which is arranged at a different location in the motor vehicle 1. Variants are also possible in which also a part of the coaxial cable 13 is integrated in the mirror base 5 so that the mirror base 5 has a contact element, for example a plug or the like.

In addition further components are arranged in the interior of the mirror base 5, for example a sensor 14 or a camera, as schematically shown in FIG. 3.

1.-10. (canceled)

11. An attachment for a motor vehicle, said attachment comprising:
an antenna for transmitting and/or receiving radio signals, said antenna having at least one conductor path, said mirror base and said at least one conductor path being configured as injection-molded interconnect device; and
a coaxial cable, wherein at least a portion of the coaxial cable is a component of the injection-molded interconnect device, wherein the at least one conductor path is electrically connected to the coaxial cable, and wherein the attachment is configured as a mirror base of an interior rear mirror and has a prismatic hollow shape.

12. The attachment of claim 11, comprising multiple said antenna and/or multiple said conductor path.

13. The attachment of claim 11, wherein the conductor path of the antenna has a three-dimensional shape adapted to a shape of the attachment.

14. A motor vehicle, comprising:
an attachment, said attachment comprising
an antenna for transmitting and/or receiving radio signals, said antenna having at least one conductor path, said mirror base and said at least one conductor path being configured as injection-molded interconnect device; and
a coaxial cable, wherein at least a portion of the coaxial cable is a component of the injection-molded interconnect device, wherein the at least one conductor path is electrically connected to the coaxial cable, and wherein the attachment is configured as a mirror base of an interior rear mirror and has a prismatic hollow shape.

15. The motor vehicle of claim 14, comprising at least one further antenna.

16. The motor vehicle of claim 15, wherein the at least one further antenna is configured as a roof antenna.
